(19) United States
(12) Patent Application Publication
(10) Pub. No.: US 2017/0024504 A1
(43) Pub. Date: Jan. 26, 2017

(54) Logical to Multi-Variable-Record Connect Element to Interface Logical Signals Between Analog and Digital Simulations

(71) Applicant: Texas Instruments Incorporated, Dallas, TX (US)

(72) Inventor: Charles M. Branch, Dallas, TX (US)

(21) Appl. No.: 15/215,773

(22) Filed: Jul. 21, 2016

Related U.S. Application Data
(60) Provisional application No. 62/195,402, filed on Jul. 22, 2015.

(51) Int. Cl. G06F 17/50

(52) U.S. Cl. CPC G06F 17/5036

(57) ABSTRACT

In described examples, embodiments include a circuit simulator having a processor and a memory. The memory stores at least one digital circuit element definition. The memory also stores at least one analog circuit element definition. The memory also stores at least one connect element definition, the connect element definition having at least one input coupled to the output of the digital circuit element definition and at least one output coupled to the analog circuit definition. The connect element definition includes at least a first current source coupled to the at least one output and a first impedance coupled to the at least one output, a signal on the at least one input determining the value of the first impedance.

### CROSS-REFERENCE TO RELATED APPLICATIONS

This application claims the benefit under 35 U.S.C. §119(e) to co-owned U.S. Provisional Patent Application Ser. No. 62/195,402, filed Jul. 22, 2015, entitled “A Logical to Multi-Variable-Record Connect Element to Interface Logical Signals Between Analog and Digital Simulators,” naming Charles M. Branch as inventor, which is hereby incorporated by reference in its entirety herein.

### TECHNICAL FIELD

This application relates generally to the simulation of integrated circuits, and, in particular, to the simulation of integrated circuits containing digital elements, analog elements and the connections between these elements.

### BACKGROUND

The design of modern integrated circuitry requires sophisticated tools. Automated design tools are necessary for all but the simplest devices. Among the most important of these tools are testing and validation tools. These tools model a design to verify that it will operate as intended. For digital circuitry, the circuit designers usually simulate at the register transfer level (RTL) to design the capabilities needed. The output of the RTL design process is an electronic file having a specific format. The RTL file is then compiled by one of a number of available software tools to provide a gate level net list for the design. A modeling tool takes the gate level net list as an input to model the operation of the circuit. Digital circuit simulation takes advantage of the nature of digital circuitry. The gates identified in the gate level net list may actually be composed of dozens of transistors for a relatively complex gate like a multiplexor. However, the nature of digital circuitry allows modeling tools to represent each gate as a logical function plus some delay factors. The inputs and outputs of these modules are almost always limited to digital signals (i.e., “1”, “0”, “X” (don't care) or “Z” (high impedance)). In current circuit simulators, there are additional drive strengths defined, including: “supply”; “pull”; “weak”; “large”, “medium”; “small” and “highz”. While these additional drives strengths are available in simulation, these drive strengths are almost never used. The use of these drive strengths has a detrimental effect on the speed of the simulation, and so they are not often used. By restricting signals in a digital simulator to these few states, the simulation is simplified. If this were not the case, simulation of a modern circuit might take weeks, even using powerful computing resources. With most designs, circuit simulations are repeated to remove design errors and to optimize the performance and area of the design. Using a transistor level simulation with true voltage levels for the design process would lead to long delays in circuit verification, and thus lead to long delays in getting a new product to market.

An added complication in modern integrated circuitry simulation is the need to include analog circuitry along with digital circuitry, i.e., to simulate mixed-signal circuits. In some circuit modeling languages, modules aggregate a number of components (transistors, resistors, diodes, etc.) within the analog module. A list of functional characteristics, sometimes called a multi-field record (MFR) describes the behavior of the model. However, unlike digital modules, the inputs and outputs of these modules are real voltage and current signals. These signals take values other than “1”, “0”, “X” and “Z” to better model the analog signals.

A significant problem occurs when a circuit being simulated includes both analog and digital circuits, known as mixed-signal circuits. Analog and digital circuits are connected in the simulation model to provide a complete model. However, the digital circuit models use only digital signals. Analog devices require a real voltage, an impedance, and a current value. The conventional techniques for connecting the analog and digital signals in simulators are either very complex or do not accurately describe the operation of the analog/digital interface.

### SUMMARY

In accordance with an example embodiment, a circuit simulator includes a processor and a memory. The memory stores a plurality of digital circuit element definitions, each of the digital circuit element definitions having at least one input, at least one output and a relationship between the at least one input and the at least one output, the relationship including timing of the at least one input and the at least one output. The memory also stores a plurality of analog circuit element definitions, each of the analog circuit element definitions including a plurality of terminals and a relationship of the signal applied to one of the plurality of terminals to a response on another one of the plurality of terminals. The memory also stores at least one connect element definition, the connect element definition has at least one input coupled to the output of one of the plurality of digital circuit element definitions and at least one output coupled to the input of one of the plurality of analog circuit definitions. The connect element includes at least a first current source coupled to the output and a first impedance coupled to the output. A signal on the input determines the value of the impedance.

### BRIEF DESCRIPTION OF THE DRAWINGS

FIG. 1 is a diagram of a mixed-signal simulation environment.

FIG. 2 is a diagram illustrating the operation of a connect element.

FIG. 3 is a diagram illustrating a connect element embodiment.

FIG. 4 is a chart showing example relationships between the inputs to the connect element of FIG. 3 and its operation.

FIG. 5 is a flow diagram for providing a mixed-signal circuit simulation in accordance with a method embodiment.

FIG. 6 is a block diagram of a system for use with an embodiment.

### DETAILED DESCRIPTION OF EXAMPLE EMBODIMENTS

Corresponding numerals and symbols in the different figures generally refer to corresponding parts unless otherwise indicated. The figures are not necessarily drawn to scale.

The term “coupled” may include connections made with intervening elements, and additional elements and various connections may exist between any elements that are “coupled.”

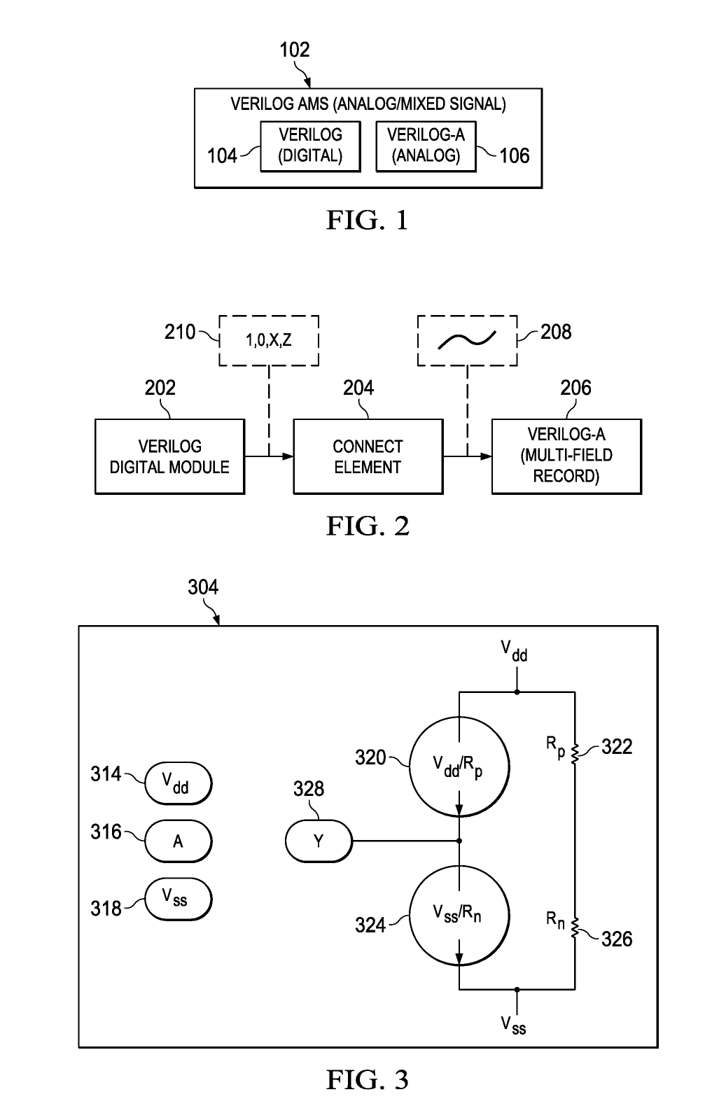

FIG. 1 is a diagram of a mixed-signal simulation environment. FIG. 1 describes the Verilog AMS environment (included in the IEEE 1364-2005 standard). An additional example of an environment suitable for aspects of the present application is the System Verilog environment (included in IEEE 1800-2012, which is an extension of IEEE 1364-2005). Verilog AMS is one simulation environment where embodiments can be employed. However, the embodiments are in no way limited to a particular circuit simulation environment. Verilog AMS 102 includes Verilog (Digital) 104 extensions that provide simulation of digital modules with Verilog-A (Analog) 106 extensions that provide simulation of analog modules. The modules in Verilog-A are often in the form of multi-field records (MFRs) where each field in a multiple field record describes a specific behavior of the module. The inputs and outputs of Verilog-A modules are in the form of wire-real (“wreal”) inputs and outputs. That is, the signals from these modules represent real voltages or real currents, as opposed to the digital values such as 1s or 0s used in digital circuit simulation models. Each field in the MFR accepts at least one input and describes the modules behavior for that field.

FIG. 2 is a diagram illustrating the use of a conventional connect element. In FIG. 2 a connect element 204 couples digital modules, such as a Verilog Digital module 202 (using Verilog (digital) environment 104, see FIG. 1) to an analog wreal module, such as a Verilog-A module 206 (using Verilog-A environment 106, see FIG. 1). Callout 210 shows that the output of Verilog digital module 202 is in the form of only digital format signals, i.e., 1, 0, X and Z. Callout 208 shows that the output of connect element 204 is in the form of real voltages and currents. Connect elements such as 204 can be a simple voltage translation. That is, a digital 1 output from Verilog digital module 202 may be translated to a V_{dd} output from connect element 204 and input to Verilog-A module 206. Conversely, a 0 output from Verilog digital module 202 can produce a Vₛₛ output from connect element 204 to Verilog-A module 206. However, this simple example connect model does not accurately reflect the driving voltages and currents that affect the operation of Verilog-A analog module 206. For example, if the signal input to the Verilog-A module 206 is an open drain circuit, the circuit simulator may not be able to provide a stable solution for the impact of that open drain input on the analog module. In addition, a conventional connect module that has transitional discontinuities (i.e., when the output immediately transitions to a new value) may cause significant simulation convergence and speed issues. Simulations may fail, or simulations may take exceedingly long times to complete due to these issues.

FIG. 3 is a diagram illustrating a connect element embodiment. Connect element 304 includes V_{dd} input 314 that sets the V_{dd} level, Vₛₛ input 318 that sets the Vₛₛ level and data input A 316. Data input 316 can be configured to accept any input that the digital modules may produce. These are usually 0, 1, X (don't care) or Z (high impedance), but this list is not exhaustive, and the other states such as “supply”, “highz” that are used in current circuit simulators can also be used. In this example embodiment, the behavior of connect element 304 is modeled on a push/pull transistor pair. However, the transistors themselves are not modeled so as to reduce computational complexity. Instead, two Thevenin equivalent circuits consisting of a current source and an impedance are used, one Thevenin circuit coupled between output Y 328 and V_{dd} and one Thevenin circuit coupled between output Y 328 and Vₛₛ. However, in an alternative embodiment a circuit designer may employ a connect element that includes only one Thevenin circuit (push or pull) in appropriate circumstances.

The Thevenin circuits have a configuration where the value of the current source is determined by the value of the impedance. For example, a pull-up Thevenin circuit in connect element 304 includes current source 320 and impedance 322. A pull-down Thevenin circuit includes current source 324 and impedance 326. The value of the current sources 320, 324 is set by the corresponding resistance 322, 326, respectively. For example, when the value of Rₚ is set, the current value of current source 320 is set at V_{dd}/Rₚ. In an alternative, the current value can be modeled as V_{dd}-Vₛₛ/Rₚ, where Vₛₛ can be other than zero volts. When the value of Rₙ is set, the current value of current source 324 is set at Vₛₛ/Rₙ. The output Y 328 of the connect element 304 can be provided as an input to the multi-field record (MFR) of the analog module, such as Verilog-A module 206 (FIG. 2).

The behavior of connect element 304 is determined by the relationship of the input on terminal A 316 to impedances Rₚ 322 and Rₙ 326. For example, if the input on A 316 is a logical 1, impedance Rₚ 322 is set to a low value and the impedance Rₙ 326 is set to a high value. The values of Rₚ 322 and Rₙ 326 that correspond to high and low signals are determined for the process technology that will be used to fabricate the circuit. These values are determined by experimentation so that the circuit simulation will match the actual components formed in silicon as closely as possible. Because impedance Rₚ 322 is set to a low value, V_{dd}/Rₚ is a high value and the current supplied by current source 320 is a high value. Because impedance Rₙ 326 is set to a high value, Vₛₛ/Rₙ is a low value and the current supplied by current source 324 is a low value. Therefore, with a very low computational overhead, module 304 accurately reflects electrical characteristics of a push-pull output stage of a digital circuit driving a logical 1 one at its output, but in the form of the actual electrical signal, not just as a logical 1.

Conversely, a logical 0 on input A 316 sets Rₚ 322 to a high value and Rₙ 326 to a low value. Therefore, current supply 320 has a low value and current supply 324 has a high value.

The connect element 304 can connect any digital and analog interfaces. In an additional example, a Verilog netlist for an RTL simulation can be coupled to a Spice or Spectre transistor level simulation by using the connect element 304, and by choosing the current source values and the impedance values appropriately.

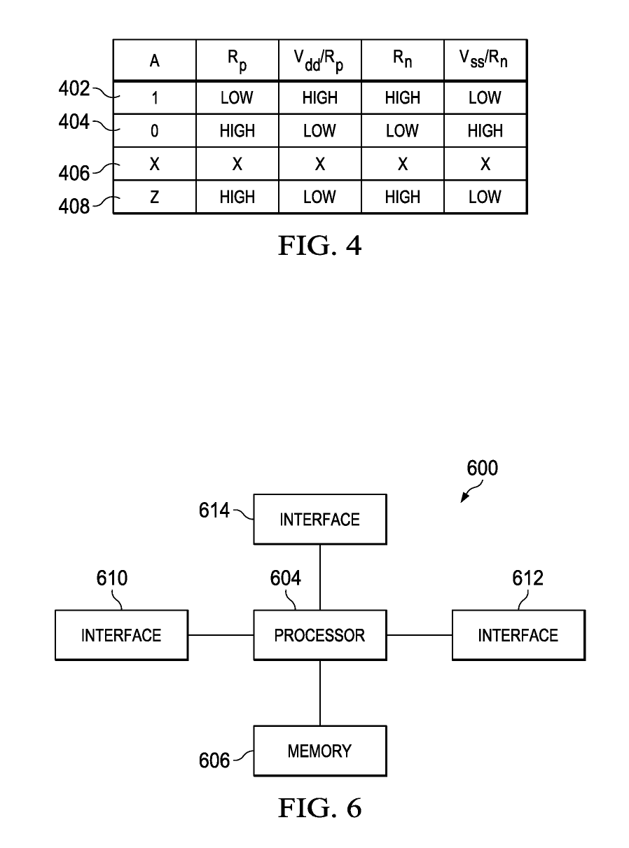

FIG. 4 is a chart showing the relationship of common inputs on A 316 to the setting of Rₚ, V_{dd}/Rₚ, Rₙ and Vₛₛ/Rₙ in connect element 304 in FIG. 3. The relationship for a logical 1 is on line 402. The relationship for a logical 0 is on line 404. The relationship for an X (don't care) is on line 406. The X (don't care) value does not show any values for Rₚ, V_{dd}/Rₚ, Rₙ and Vₛₛ/Rₙ because X is not usually an actual output, but more often refers to a digital input behavior. The relationship for a Z input (high impedance) is shown on line 408. While specific relationships are illustrated in FIG. 4, these relationships are only examples. Any relationship that exists between an input signals on A 316 and the values of Rₚ 322 and Rₙ 326 can be defined in the embodiments.

In addition, the timing of transition from one set of R_{P} and R_{N} values to another set can be included in the relationship definition. For example, if a logical 1 is on input A and then transitions to logical 0, the relationship definition can include a certain amount of time for Rₚ to transition from low to high impedance and for Rₙ to transition from a high to a low impedance. The connect element 304 may also include transition times for its other parameters as well. In addition, with transition timing, the relationship for connect element 304 may also define if the transition is linear or if it is some other function.

As an example, the source code for a connect element in accordance with an embodiment that is described using SystemVerilog code is shown in Appendix I.

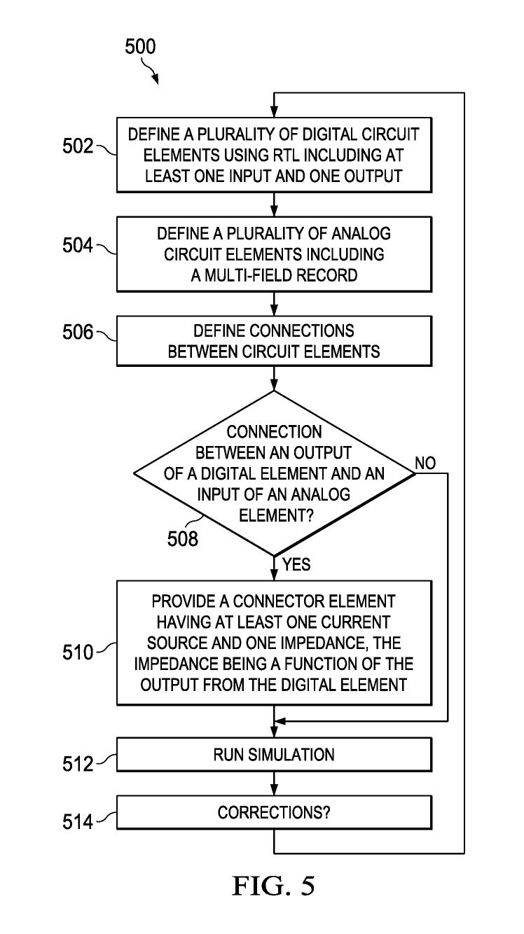

FIG. 5 illustrates in a flow diagram 500 the steps for a method embodiment. The method provides a mixed-signal circuit simulation embodiment. In step 502, the method begins by defining a plurality of digital circuit elements using RTL. At step 504, the method defines a plurality of analog circuit elements using a multi-field record. At step 506, the method defines connection between the elements defined in steps 502 and 504. At step 508, a decision is performed. Step 508 determines whether the connections defined in step 506 are between the output of a digital circuit element and the input of an analog circuit element. If the determination is true, the method transitions to step 510. At step 510 the method provides a connector element in accordance with connect element 304 (FIG. 3). If the determination at step 508 is false, the method transitions to step 512 and a normal simulation connection is provided. At step 512, the method runs the simulation. At step 514, the method identifies necessary corrections from the simulation results and loops to step 502. At step 502, the method makes changes in the digital definitions, analog definitions or connections to make the corrections and the method is again performed.

FIG. 6 illustrates a block diagram of a processing system 600 that may implement an embodiment, such as that of FIG. 3. In FIG. 6 the processing system 600 includes a processor 604, a memory 606, and interfaces 610-614, which may (or may not) be arranged as shown in FIG. 6. The processor 604 may be any component or collection of components adapted to perform computations and/or other processing related tasks, and the memory 606 may be any component or collection of components adapted to store programming and/or instructions for execution by the processor 604. The processor can be a workstation, personal computer, laptop computer, or mainframe. The processor can be a dedicated processor for circuit simulations. In an alternative arrangement, the processor can be a general purpose computer. In an example embodiment, the memory 606 includes a non-transitory computer readable medium. The memory 606 can be a FLASH module or other non-volatile memory. The memory 606 can be transferred between circuit simulation environments. The memory 606 can be a server addressed on a network. The memory 606 can be a storage located in an internet connected cloud service. The interfaces 610, 612, 614 may be any component or collection of components that allow the processing system 600 to communicate with other devices/components and/or a user. For example, one or more of the interfaces 610, 612, 614 may be adapted to communicate data, control, or management messages from the processor 604 to applications installed on the host device and/or a remote device. As another example, one or more of the interfaces 610, 612, 614 may be adapted to allow a user or user device (e.g., personal computer (PC), laptop, workstation, etc.) to interact/communicate with the processing system 600. The processing system 600 may include additional components not depicted in FIG. 6, such as long term storage (e.g., disk storage, non-volatile memory, etc.).

In some embodiments, the processing system 600 is included in a network device that is accessing, or otherwise part of, a telecommunications network. In one example, the processing system 600 is in a network-side device in a wireless or wireline telecommunications network, such as a base station, a relay station, a scheduler, a controller, a gateway, a router, an applications server, or any other device in the telecommunications network. In other embodiments, the processing system 600 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

A connect element of an example embodiment emulates a digital output stage with good accuracy and is computationally efficient. Circuit simulations performed using the embodiments provide benefits including that delays and transition times within the connect element are accurately modeled, thus allowing accurate circuit simulation for timing sensitive circuits. In addition, in a circuit simulator incorporating the embodiments, the impact of multiple connect element drivers in connected parallel can be correctly modeled with correct resolution of both electrical signals and timing, allowing for fast circuit simulation of clock mesh networks and other networks.

In addition, use of the embodiments enables the circuit simulator to resolve open drain interfaces such as used for the I2C bus interface. Use of the embodiments make it possible to resolve current mode interfaces and differential mode logic having these interfaces in circuit simulations. The impedance elements in the connect elements of the embodiments allow accurate dynamic power simulation of digital circuits. The connect elements properly model current contention and crowbar current in circuit simulations.

In described examples, embodiments include a circuit simulator having a processor and a memory. The memory stores at least one connect element definition, and the connect element definition has at least one input coupled to the output of a digital circuit element definition and at least one output coupled to an input of analog circuit definition. The connect element definition includes a first current source coupled to the at least one output and a first impedance coupled to the at least one output, a signal on the input determining the value of the first impedance.

In a further example embodiment, in the connect element definition in the circuit simulator, the current source and the first impedance are coupled between the output of the connect element definition and a reference potential. In another example embodiment, a value of the first current source in the connect element definition is determined by the signal on the at least one input.

In a further example embodiment, the connect element definition includes a second current source coupled between the output and a first potential, and further includes a second impedance coupled between the output and the first potential, the signal on the input determining a value of the second impedance.

In still another example embodiment, the connect element definition includes a value of the first current source that is inversely proportional to a value of the first impedance. In yet another example, the connect element definition includes a value of the second current source determined by a signal on the input. In still another example, the connect element definition includes the value of the second current source that is inversely proportional to the value of the second impedance.

In an alternative example, the connect element definition includes timing definitions for a transition of a value of the first impedance when a signal on the input transitions from one value to another value.

In a further example, the connect element definition includes including a plurality of interconnect definitions stored in the memory defining interconnections between the plurality of digital circuit element definitions, the plurality of analog circuit element definitions and the at least one connect element definition.

In another example embodiment, a circuit simulator includes: a processor; a memory; and at least one connect element definition stored in the memory, the at least one connect element definition having at least one input coupled to an output of at least one digital circuit element definition and at least one output coupled to at least one analog circuit definition, the connect element definition including a first current source coupled to the at least one output and a first impedance coupled to the at least one output, and a signal on the at least one input determining a value of the first impedance.

In a further example embodiment, in the circuit simulator the first current source and the first impedance in the connect element definition are coupled between the output of the connect element definition and a reference potential.

In yet another example embodiment, in the circuit simulator the value of the first current source in the at least one connect element definition is inversely proportional to a value of the first impedance.

In still a further example embodiment, in the circuit simulator the at least one connect element definition includes timing definitions for a transition of the value of the first impedance when a signal on the at least one input transitions from one value to another value.

In yet another example embodiment, in the circuit simulator the at least one connect element definition further includes: a second current source coupled between the at least one output and a first potential; and a second impedance coupled between the at least one output and the first potential; a signal on the input determining a value of the second impedance. In another alternative example, in the circuit simulator, a value of the second current source in the at least one connect element definition is inversely proportional to a value of the second impedance.

In another example embodiment, a method includes: defining a plurality of digital circuit elements, each of the digital circuit elements having at least one input, at least one output and a relationship between the at least one input and the at least one output′ and the relationship including timing of the at least one input and the at least one output. The method also includes defining a plurality of analog circuit elements, each of the analog circuit elements including a plurality of terminals and a relationship of the signal applied to one of the plurality of terminals to a response on another one of the plurality of terminals. The method further includes defining at least one connect element, the connect element having at least one input coupled to the output of one of the plurality of digital circuit elements and at least one output coupled to one of the plurality of analog circuit elements.

In another example, in the method the connect element includes a first current source coupled between the output and a first potential, a first impedance coupled between the output and the first potential, a second current source coupled between the output and a second potential, and a second impedance coupled between the output and the second potential, a signal on the input determining the value of the impedance. The method also includes executing a simulation of a circuit using the digital circuit elements, the analog circuit elements and the connect elements.

In still another example embodiment, in the method, the method includes defining interconnections between the digital circuit elements, the analog circuit elements and the connect elements. In yet another example embodiment, in the method, the method includes determining the value of the first current source by the signal on the input and determining a value of the first current source inversely proportional to the value of the first impedance. In yet another example, in the method, the method includes determining a value of the second current source by the signal on the input and determining the value of the second current source inversely proportional to a value of the second impedance.

In still another example embodiment, in the method, the method includes defining the at least one connect element includes defining timing for a transition of a value of the first impedance when a signal on the at least one input transitions from one value to another value.

Modifications are possible in the described embodiments, and other embodiments are possible within the scope of the claims.

```
APPENDIX I
module asv21( input real vdd,
        input real vss,
        input asv_pin a,
        output logic y);
      timeunit 1ps;
    timeprecision 100fs;
        parameter real pvdd_min = 0.7*(1.2);
        parameter real vss_max = 0.1*(0);
        parameter real p_rhz = 200e6;
      parameter real txdel = 20ps;
        real vih;
        real vil;
        logic vdd_ok;
        logic a_hi;
        logic a_lo;
        logic a_z;
        logic R_conv;
        logic Xin;
        assign vih = 0.8*(vdd − vss);
        assign vil = 0.2*(vdd − vss);
        assign vdd_ok = (vdd − vss) >= pvdd_min;
        // the 100fs delay should be the time precision step to filter any zero
time events
  assign #100fs a_hi = vdd_ok & (a.voltage > vih);
  assign #100fs a_lo = vdd_ok & (a.voltage < vil);
  assign #100fs a_z = vdd_ok & (a.res_s > p_rhz);
        always @(a_hi, a_lo, a_z)
          begin
            if (a_z)
              begin
                R_conv = 1′bz;
                Xin = 0;
                disable GoToX;
              end
            else if (a_hi)
              begin
                R_conv = 1′b1;
                Xin = 0;
                disable GoToX;
              end
            else if (a_lo)
              begin
                R_conv = 1′b0;
                Xin = 0;
                disable GoToX;
              end
            else
              begin
                Xin = 1;
              end
          end
          // see if it is a stable X
          always @ (posedge(Xin))
            begin: GoToX
              #txdel;
              if (Xin == 1)
                R_conv = 1′bx;
            end
          assign y = R_conv;
            endmodule
    module 12asv(
        input real vdd,
        input real vss,
        input logic a,
        inout asv_pin y);
        timeunit 1ps;
        timeprecision 100fs;
        parameter real p_rp = 50.0;
        parameter real p_rn = 50.0;
        parameter real p_rpz = 1.0e9;
        parameter real p_rnz = 1.0e9;
        parameter real p_vdd = 1.2;
        parameter rise_delay = 40;
        parameter fall_delay = 40;
        parameter ts_delay = 40;
        parameter rise_time = 10;
        parameter fall_time = 10;
        parameter ts_time = 10;
```

| | |
|---|---|
| real | rp, rn; |
| real | rp0, rn0; |
| real | currentp; |
| real | currentn; |
| real | y_voltage; |
| real | y_current; |
| real | y_resistance; |
| logic | vdd_ok; |
| logic | a_last; |

```
        integer T;
        initial begin
```

| | |
|---|---|
| rp = p_rp; | // Start out in the X state |
| rn = p_rn; | // Start out in the X state |

```
        end
        always @(a,vdd_ok)
          begin
            T = 0;
            rp0 = rp;
            rn0 = rn;
            while (T < 2*ts_delay)
              begin
                if (!vdd_ok)
                    begin
                      if (rp != p_rp)
                          rp = p_rp + (rp0 − p_rp) * ( 1 − 1/(1+$exp((T − ts_delay)
    ts_time)));
                      if (rn != p_rn)
                          rn = p_rn + (rn0 − p_rn) * ( 1 − 1/(1+$exp((T −
ts_delay)/ts_time)));
                    end
                else if (a === 1′bz)
                    begin
                      if (rp != p_rpz)
                          rp = rp0 + (p_rpz − rp0) * ( 1/(1+$exp((T − ts_delay)/ts_time)));
                      if (rn != p_rnz)
                          rn = rn0 + (p_rnz − rn0) * ( 1/(1+$exp((T − ts_delay)/ts_time)));
                    end
                else if ( a === 1′b0)
                    begin
                      if (rp != p_rpz)
                          rp = rp0 + (p_rpz − rp0) * ( 1 − 1/(1+$exp((T−
ts_delay)/ts_time)));
                      if (rn != p_rn)
                          rn = p_rn + (rn0 − p_rn) * ( (1/(1+$exp((T−
fall_delay)/fall_time))));
                  end
                else if ( a === 1′b1)
                    begin
                      if (rp != p_rp)
                          rp = p_rp + (rp0 − p_rp) * ( (1/(1+$exp((T −
rise_delay)/rise_time))));
                      if (rn != p_rnz)
                          rn = rn0 + (p_rnz − rn0) * ( 1 − 1/(1+$exp((T −
ts_delay)/ts_time)));
                    end
                  else
                    begin
                      if (rp != p_rp)
                          rp = p_rp + (rp0 − p_rp) * ( 1 − (1/(1+$exp((T −
rise_delay)/rise_time))));
                      if (rn != p_rn)
                          rn = p_rn + (rn0 − p_rn) * ( 1 − (1/(1+$exp((T −
fall_delay)/fall_time))));
                    end
                #1;
                        if (a != a_last)
                            begin
                        rp0 = rp;
                              rn0 = rn;
                                T = 0;
                    end
                else
                    T = T + 1;
              end // while
              if (!vdd_ok)
                begin
                    rp = p_rp;
                    rn = p_rn;
                end
              else if (a === 1′bz)
                begin
                    rp = p_rpz;
                    rn = p_rnz;
                end
              else if ( a === 1′b0)
                begin
                    rp = p_rpz;
                    rn = p_rn;
                end
              else if ( a === 1′b1)
                begin
                    rp = p_rp;
                    rn = p_rnz;
                end
              else
                begin
                    rp = p_rp;
                    rn = p_rn;
                end
              rp0 = rp;
              rn0 = rn;
            end // always
        always @(a)
          a_last <= #1 a;
        assign vdd_ok = (vdd >= p_vdd*0.7);
        assign y_current = vss/rn + vdd/rp;
        assign y_resistance = ((rn*rp)/(rn + rp));
        assign y_voltage = y_current * y_resistance;
        assign y = asv_rec′{y_voltage,y_current,y_resistance};
    end module
```

What is claimed is:

1. A circuit simulator comprising:
a processor;
a memory;
a plurality of digital circuit element definitions stored in the memory, each of the digital circuit element definitions having at least one input, at least one output and defining a relationship between the at least one input and the at least one output, the relationship including timing of the at least one input and the at least one output;
a plurality of analog circuit element definitions stored in the memory, each of the analog circuit element definitions including a plurality of terminals and defining a relationship of a signal applied to one of the plurality of terminals to a response output on another one of the plurality of terminals; and
at least one connect element definition stored in the memory, the connect element definition having at least one input coupled to the output of one of the plurality of digital circuit element definitions and at least one output coupled to one of the plurality of analog circuit element definitions, the connect element definition including a first current source coupled to the output and a first impedance coupled to the output, and a signal on the input determining a value of the first impedance.

2. The circuit simulator of claim 1 in which the first current source and the first impedance in the connect element definition are coupled between the output of the connect element definition and a reference potential.

3. The circuit simulator of claim 1 in which a value of the first current source is determined by the signal on the input.

4. The circuit simulator of claim 1 in which the connect element definition further includes a second current source coupled between the output and a first potential, and further includes a second impedance coupled between the output and the first potential, the signal on the input determining a value of the second impedance.

5. The circuit simulator of claim 4 in which a value of the first current source in the connect element definition is inversely proportional to the value of the first impedance.

6. The circuit simulator of claim 4 in which a value of the second current source in the connect element definition is determined by a signal on the input.

7. The circuit simulator of claim 6 in which the value of the second current source in the connect element definition is inversely proportional to the value of the second impedance.

8. The circuit simulator of claim 1 in which the connect element definition includes timing definitions for a transition of a value of the first impedance when a signal on the input transitions from one value to another value.

9. The circuit simulator of claim 1 further including a plurality of interconnect definitions stored in the memory defining interconnections between the plurality of digital circuit element definitions, the plurality of analog circuit element definitions and the at least one connect element definition.

10. A circuit simulator comprising:
a processor;
a memory; and
at least one connect element definition stored in the memory, the at least one connect element definition having at least one input coupled to an output of at least one digital circuit element definition and at least one output coupled to at least one analog circuit definition, the connect element definition including a first current source coupled to the at least one output and a first impedance coupled to the at least one output, and a signal on the at least one input determining a value of the first impedance.

11. The circuit simulator of claim 10 in which the first current source and the first impedance in the connect element definition are coupled between the output of the connect element definition and a reference potential.

12. The circuit simulator of claim 10 in which the value of the first current source in the at least one connect element definition is inversely proportional to a value of the first impedance.

13. The circuit simulator of claim 10 in which the at least one connect element definition includes timing definitions for a transition of the value of the first impedance when a signal on the at least one input transitions from one value to another value.

14. The circuit simulator of claim 10 in which the at least one connect element definition further includes a second current source coupled between the at least one output and a first potential, and further includes a second impedance coupled between the at least one output and the first potential, a signal on the input determining a value of the second impedance.

15. The circuit simulator of claim 14 in which a value of the second current source in the at least one connect element definition is inversely proportional to a value of the second impedance.

16. A method, comprising:
defining at least one digital circuit element, the digital circuit element having at least one input, at least one output and defining a relationship between the at least one input and the at least one output, the relationship including timing of the at least one input and the at least one output;
defining at least one analog circuit element, the analog circuit element including a plurality of terminals and defining a relationship of a signal applied to one of the plurality of terminals to a response on another one of the plurality of terminals;
defining at least one connect element, the connect element having at least one input coupled to the output of the digital circuit element and at least one output coupled to the analog circuit element, the connect element including a first current source coupled between the output and a first potential, a first impedance coupled between the output and the first potential, a second current source coupled between the output and a second potential, and a second impedance coupled between the output and the second potential, and a signal on the input determining a value of the first impedance; and
executing a simulation of a circuit using the digital circuit elements, the analog circuit elements and the connect elements.

17. The method of claim 16, further including defining interconnections between the digital circuit elements, the analog circuit elements and the connect elements.

18. The method of claim 16 further including determining the value of the first current source by the signal on the input and determining a value of the first current source inversely proportional to the value of the first impedance.

19. The method of claim 16 further including determining a value of the second current source by the signal on the input and determining the value of the second current source inversely proportional to a value of the second impedance.

20. The method of claim 16 in which defining the at least one connect element includes defining timing for a transition of a value of the first impedance when a signal on the at least one input transitions from one value to another value.
